(19) United States
(12) Patent Application Publication
(10) Pub. No.: US 2024/0154965 A1
(43) Pub. Date: May 9, 2024

(54) SYSTEM AND METHOD FOR ACCESS CONTROL BASED ON DOMAIN NAME OF CLOUD SERVICE

(71) Applicant: SOMANSA CO., LTD., Seoul (KR)

(72) Inventors: Tae Wan KIM, Seoul (KR); Tae Suk Kim, Seoul (KR)

(21) Appl. No.: 18/065,033

(22) Filed: Dec. 13, 2022

(30) Foreign Application Priority Data
Nov. 9, 2022 (KR) 10-2022-0148498

(51) Int. Cl. H04L 9/40

(52) U.S. Cl. CPC H04L 63/10

(57) ABSTRACT

A system comprises: an endpoint configured to look up a domain name for at least one cloud service, an application cloud service, and a database cloud service and transmit context information; and a security gateway configured to set up a domain name list of the cloud service and perform context-based access control of the endpoint to the cloud service using the context information transmitted from the endpoint, wherein the endpoint comprises: a domain name system client configured to store domain cache information and an IP address corresponding to the domain name; and a traffic forwarding agent configured to update domain matching information for each IP address of the domain name list provided from the security gateway, generate the context information for the cloud service through a lookup of the domain cache information or the domain matching information, and transmit the generated context information to the security gateway.

### CROSS-REFERENCE TO RELATED APPLICATION

This application claims priority from Korean Patent Application No. 10-2022-0148498 filed on Nov. 9, 2022 in the Korean Intellectual Property Office, and all the benefits accruing therefrom under 35 U.S.C. 119, the contents of which in its entirety are herein incorporated by reference.

### TECHNICAL FIELD

The present disclosure relates to a system and method for access control based on a domain name of a cloud service for providing a cloud-based information leakage prevention solution.

### BACKGROUND

Network security solutions such as network information leakage prevention, secure web gateway, and cloud access security broker provide cloud service access control functions that control access to cloud services such as web cloud services, application cloud services, and database cloud services. A security gateway controls access according to forwarded context information and forwards an allowed connection and traffic to the final cloud service.

However, since the IP address of the cloud service is a floating IP address that is not fixed and can be changed, the IP address of the cloud service is not suitable for use as server context for context-based access control. Rather, a domain name of the cloud service is suitable for use as the server context.

In the case of cloud web services, service name indication (SNI) of TLS handshake or domain name of HTTP host header field may be used as server context information. However, in the case of application or database cloud services, it is difficult to obtain a domain name of a cloud service from an IP address of the cloud service in the security gateway. A method of obtaining a domain name of a cloud service by performing a reverse domain name system (DNS) lookup from a security gateway with an IP address of the cloud service is not suitable because a public DNS server generally does not allow a reverse lookup. A method of obtaining a domain name of a cloud service by a security gateway is not suitable because when a DNS server to be looked up by a security gateway is different from a DNS server looked up by an endpoint client, DNS lookup results may differ and thus not be matched. Therefore, there is a need for a method of providing a domain name of a cloud service as server context information for context-based access control from an endpoint.

### RELATED ART DOCUMENT

(Patent Document 0001) Korean Patent Registration No. 10-1971225 (published on Apr. 22, 2019)

### SUMMARY

Aspects of the present disclosure provide a system and method for access control based on a domain name of a cloud service, in which an endpoint provides a security gateway with a domain name of a cloud service as server context information for context-based access control for the cloud service.

According to an aspect of the present disclosure, there is provided a system for access control based on a domain name of a cloud service, including: an endpoint configured to look up a domain name for at least one cloud service among a web cloud service, an application cloud service, and a database cloud service and transmit context information including the looked up name; and a security gateway configured to set up a domain name list of the cloud service and perform context-based access control of the endpoint to the cloud service using the context information transmitted from the endpoint, wherein the endpoint includes a domain name system (DNS) client configured to store domain cache information including the domain name and an IP address corresponding to the domain name; and a traffic forwarding agent configured to update domain matching information for each IP address of the domain name list provided from the security gateway, generate the context information for the cloud service through a lookup of the domain cache information or the domain matching information, and transmit the generated context information to the security gateway.

The context information may include an IP address of the cloud service and a domain name corresponding to the IP address.

The security gateway may block or allow a connection of the endpoint to the cloud service by using the context information transmitted by the traffic forwarding agent and access policy information for the cloud service.

The traffic forwarding agent may update the domain matching information by first looking up the domain cache information stored in the DNS client, and when the IP address of the domain name list does not exist in the domain cache information, update the domain matching information by looking up a DNS server.

The traffic forwarding agent may generate the context information by first looking up the domain cache information stored in the DNS client, and when the domain name and the IP address for the cloud service do not exist in the domain cache information, may generate the context information by looking up the domain matching information stored in the traffic forwarding agent, in order to obtain a domain name and an IP address for the cloud service.

The traffic forwarding agent may transmit the context information to the security gateway using either an HTTP tunneling method or a SOCKS tunneling method.

According to another aspect of the present disclosure, there is provided a method for access control based on a domain name of a cloud service including: setting up, at a security gateway, a domain name list of a cloud service including at least one of a web cloud service, an application cloud service, or a database cloud service; updating, at a traffic forwarding agent of an endpoint, domain matching information for each IP address of the domain name list provided from the security gateway; generating, at the traffic forwarding agent, context information for the cloud service through a lookup of domain cache information of a DNS client including a domain name and an IP address corresponding to the domain name or the domain matching information stored in the traffic forwarding agent itself and transmitting the generated context information to the security gateway; and performing, at the security gateway, context-based access control of the endpoint to the cloud service using the context information transmitted from the traffic forwarding agent.

The context information may include an IP address of the cloud service and a domain name corresponding to the IP address.

The updating of the domain matching information may include updating the domain matching information by first looking up the domain cache information stored in the DNS client, and, when the IP address of the domain name list does not exist in the domain cache information, updating the domain matching information by looking up a DNS server.

The generating of the context information may include, in order to obtain a domain name and an IP address for the cloud service, generating the context information by first looking up the domain cache information stored in the DNS client, and when the domain name and the IP address for the cloud service do not exist in the domain cache information, generating the context information by looking up the domain matching information.

The transmitting of the context information to the security gateway may include transmitting the context information to the security gateway using either an HTTP tunneling method or a SOCKS tunneling method.

The performing of the context-based access control may include blocking or allowing a connection of the endpoint to the cloud service by using the context information transmitted by the traffic forwarding agent and access policy information for the cloud service.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating a system for access control based on a domain name of a cloud service according to the present disclosure;

FIG. 2 is a detailed block diagram illustrating an endpoint shown in FIG. 1;

FIG. 3 is a flowchart illustrating a method for access control based on a domain name of a cloud service according to the present disclosure; and

FIG. 4 is a flowchart illustrating a process of generating and transmitting context information shown in FIG. 3.

### DETAILED DESCRIPTION OF THE EMBODIMENTS

Reference will now be made in detail to example embodiments, examples of which are illustrated in the accompanying drawings. However, the present disclosure is not limited to the embodiments described hereinafter. Rather, these embodiments are provided so that this disclosure will be thorough and complete, and will fully convey the concept of the invention to one of ordinary skill in the art.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. Also, as used herein, the term “and/or” includes any and all combinations of one or more of the associated listed items.

Embodiments of the disclosure will be described hereinafter with reference to the drawings in which embodiments of the disclosure are schematically illustrated.

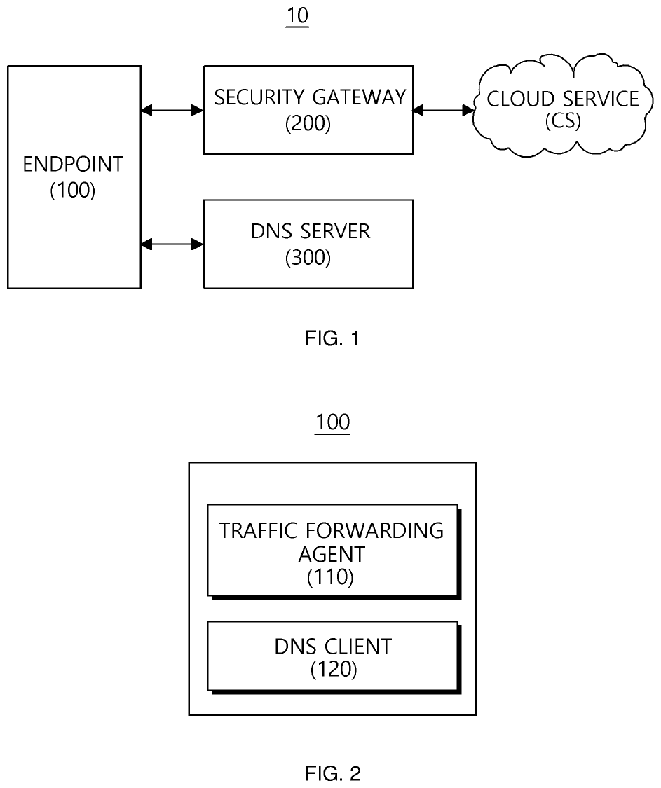

FIG. 1 is a block diagram illustrating a system for access control based on a domain name of a cloud service (hereinafter referred to as an access control system) based on a domain name of a cloud service according to the present disclosure.

Referring to FIG. 1, an access control system 10 may include an endpoint 100 and a security gateway 200, and may also include a domain name system (DNS) server 300 as a component related thereto.

The endpoint 100 looks up a domain name for an IP address of the cloud service CS and transmits context information including the looked up domain name to the security gateway 200. The cloud service CS may include a web cloud service, an application cloud service, a database cloud service, and the like.

FIG. 2 is a block diagram illustrating the endpoint 100 shown in FIG. 1.

Referring to FIG. 2, the endpoint 100 includes a traffic forwarding agent 110 and a domain name system (DNS) client 120.

The traffic forwarding agent 110 updates domain matching information for each IP address of a domain name list provided from the security gateway 200.

The domain name list is information set in the security gateway 200 and provided to the traffic forwarding agent 110 of the endpoint 100, and is a list of domain names that are targets of access control for the cloud service CS.

The traffic forwarding agent 110 performs a DNS lookup to obtain an IP address for a domain name included in the domain name list. That is, the traffic forwarding agent 110 performs a lookup of an IP address that corresponds to a domain name that is a target of access control for a cloud service, which is referred to as a DNS lookup.

When the traffic forwarding agent 110 receives the domain name list set in the security gateway 200, the traffic forwarding agent 110 searches for an IP address corresponding to the domain name and updates domain matching information consisting of the domain name and the corresponding IP address. Also, the traffic forwarding agent 110 periodically looks up the IP address for the domain name which is a target of access control for the cloud service and updates the domain matching information.

The traffic forwarding agent 110 performs a DNS lookup by calling the DNS lookup function, such as ‘gethostbyname( )’ or ‘getaddrinfo( )’. First, the DNS lookup function looks up whether the DNS client 120 has a domain name and an IP address corresponding to the domain name. Accordingly, the DNS client 120 searches the autonomously managed DNS cache to check whether the requested domain name and IP address exist, and if the requested domain name and IP address exist, returns the requested domain name and IP address to the traffic forwarding agent 110.

In addition, when the domain name and the IP address corresponding thereto, which are requested by the DNS lookup function, do not exist in the DNS cache of the DNS client 120, the DNS lookup function looks up whether the domain name and the IP address corresponding thereto exist in the DNS server 300. Accordingly, the DNS server 300 returns a domain and an IP address corresponding thereto that are stored in the DNS server 300 to the DNS lookup function. Accordingly, the traffic forwarding agent 110 updates the domain matching information in which the IP address returned from the DNS client 120 or the DNS server 300 is matched with the domain name.

Thereafter, the traffic forwarding agent 110 generates context information regarding the cloud service through lookup of domain cache information provided from the DNS client 120 or the autonomously updated and stored domain matching information according to a connection request for the cloud service, and transmits the generated context information to the security gateway 200.

The context information generated by the traffic forwarding agent 110 may include an IP address of the cloud service and a domain name corresponding to the IP address.

A connection request event for the cloud service occurs when a client (not shown) such as a web browser, a messenger, a database query tool, and the like running on the end point 100 connects to the cloud service. Since the client needs the IP address of the cloud service to access the cloud service, the client obtains the IP address for the domain name of the cloud service to access and connects to the IP address of the cloud service.

When the client requests a connection for the cloud service, the traffic forwarding agent 110 intercepts and redirects the client's connection request for the cloud service CS. Then, the traffic forwarding agent 110 looks up the domain name for the IP address of the cloud service CS, which is a final destination of the redirected connection, from domain cache information of the DNS cache managed by the DNS client 120 of an operating system.

When the domain name for the IP address of the final destination exists in the domain cache information, the traffic forwarding agent 110 receives the corresponding domain name from the domain cache information. Then, the traffic forwarding agent 110 generates context information including the corresponding IP address and the received domain name and transmits the generated context information to the security gateway 200.

On the other hand, when the domain name for the final destination IP address does not exist in the domain cache information of the DNS client 120, the traffic forwarding agent 110 looks up the domain matching information stored therein. Thereafter, the traffic forwarding agent 110 generates context information including the corresponding IP address and the domain name corresponding thereto that are looked up from the domain matching information and transmits the generated context information to the security gateway 200.

The traffic forwarding agent 110 transmits the context information to the security gateway 200. The context information may be included in HTTP extension heater field, SOCKS authentication extension field, such as JSON parameter block authentication of SOCKS5, or the like. The traffic forwarding agent 110 transmits the context information to the security gateway 200 using HTTP tunneling or SOCKS tunneling.

The DNS client 120 stores, in the domain cache, domain cache information that includes the domain name used for the cloud service and the IP address corresponding to the domain name. Then, the DNS client 120 updates the domain name and the IP address corresponding to the domain name, which are stored in the domain cache, according to calling of a DNS lookup function such as gethostbyname ( ) or getaddrinfo ( ).

The security gateway 200 sets up a domain name list of the cloud service to be access controlled. Here, the domain name list is a list of domain names that are targets of access control for the cloud service CS.

Thereafter, the security gateway 200 performs context-based access control of the endpoint 100 to the cloud service using the context information transmitted from the endpoint 100.

The security gateway 200 blocks or allows a connection of the endpoint 100 to the cloud service by using the context information transmitted by the traffic forwarding agent 110 and pre-stored access policy information for controlling whether to allow access to the cloud service.

The security gateway 200 provides a context-based access control function for a request of the endpoint 100 for connection to a web cloud service, an application cloud service, a database cloud service, or the like. When receiving a connection to the cloud service requested by the traffic forwarding agent 110, the security gateway 200 performs access control to block or allow access to the cloud service by comparing the context information, such as a user, an endpoint, a client, a server, and the like, included in connection request information with the access policy information that indicates whether to block or allow access according to conditions, such as a user, an endpoint, a client, a server, and the like. When the access is allowed, the security gateway 200 forwards the connection to the cloud service, which is a final destination. The context information includes a domain name of a cloud service, as well as an IP address of a cloud service.

For example, the security gateway 200 receives HTTP tunneling or SOCKS tunneling, which is a connection to the cloud service forwarded by the traffic forwarding agent 110, performs access control to block or allow access to the cloud service by comparing the context information, such as a user, an endpoint, a client, a server, or the like, included in connection information of the HTTP extension header filed or SOCKS authentication extension with the access policy information that indicates whether to block or allow access according to conditions, such as a user, an endpoint, a client, a server, and the like. When the access is allowed, the security gateway 200 forwards the connection to the cloud service, which is a final destination.

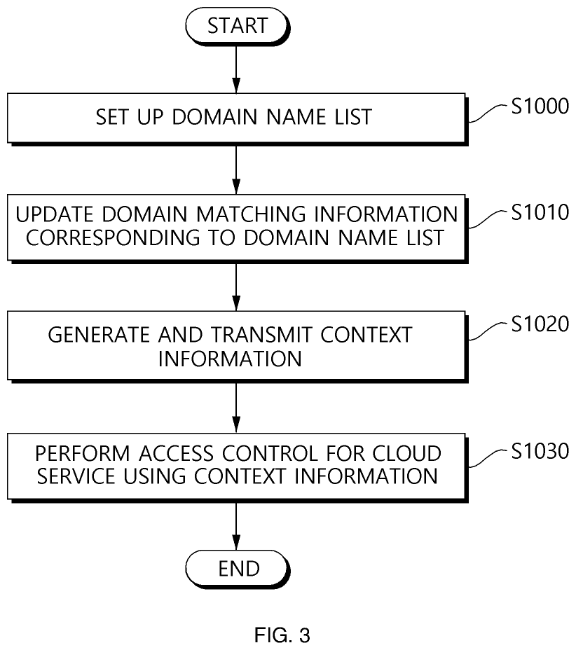

FIG. 3 is a flowchart illustrating a method for access control based on a domain name of a cloud service according to the present disclosure.

First, a security gateway sets up a domain name list of a cloud service including at least one of a web cloud service, an application cloud service, or a database cloud service (operation S1000).

After operation S1000, the traffic forwarding agent 110 updates domain matching information for each IP address of the domain name list provided from the security gateway (operation S1010). A traffic forwarding agent of the endpoint first updates the domain matching information by first looking up domain cache information stored in a DNS client, and when the IP address of the domain name list does not exist in the domain cache information, updates the domain matching information by looking up the IP address of the domain name list in a DNS server.

The traffic forwarding agent performs a DNS lookup by calling the DNS lookup function, such as ‘gethostbyname( )’ or ‘getaddrinfo( )’. First, the DNS lookup function looks up whether the corresponding domain name and the IP address corresponding thereto exist in domain cache information of a DNS client. When the domain name and the IP address that are requested by the traffic forwarding agent exist in the domain cache information of the DNS client, the DNS client returns the domain name and the IP address to the traffic forwarding agent. On the other hand, when a domain name requested by the DNS lookup function and an IP address corresponding thereto do not exist in the domain cache information of the DNS client, the DNS lookup function looks up whether the domain name and the IP address corresponding thereto exist in the DNS server. Accordingly, the DNS server returns the domain name and the IP address corresponding thereto that are stored in the DNS server to the DNS lookup function. Thus, the traffic forwarding agent may update the domain matching information in which the IP address returned from the DNS client or the DNS server is matched with the domain name.

After operation S1010, the traffic forwarding agent of the endpoint generates context information regarding the cloud service through a lookup of domain cache information including an IP address and a domain name corresponding to the IP address, or the domain matching information, and transmits the generated context information to the security gateway (operation S1020). The context information includes an IP address of a cloud service and a domain name of a cloud service.

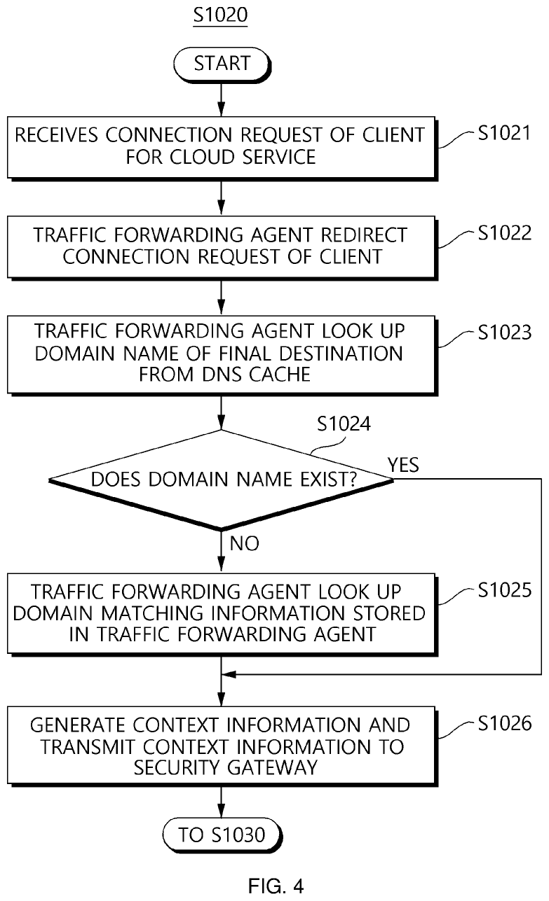

FIG. 4 is a flowchart illustrating a process of generating and transmitting the context information shown in FIG. 3.

When a client, such as a web browser, a messenger, a database query tool, or the like, requests the endpoint for a connection to a cloud service, the endpoint receives a request for a connection to the cloud service (operation S1021). Thereafter, the traffic forwarding agent of the endpoint intercepts the client's connection request for the cloud service and redirects the connection request to the traffic forwarding agent (operation S1022). Then, the traffic forwarding agent looks up a domain name for an IP address of a redirected final destination from the DNS cache managed of the DNS client (operation S1023).

The traffic forwarding agent of the endpoint checks whether the domain name for the final destination IP address exists in the domain cache information of the DNS cache (operation S1024), and when the domain name for the final destination IP address exists in the domain cache information, the traffic forwarding agent generates context information which includes the domain name and the final destination IP address that are looked up from the domain cache information of the DNS client, and transmits the generated context information to a security gateway (operation S1026). On the other hand, when the domain name for the final destination IP address does not exist in the DNS client, the traffic forwarding agent looks up the domain matching information stored therein (operation S1025). Thereafter, the traffic forwarding agent generates context information which includes the domain name and the final destination IP address that are looked up from the domain matching information, and transmits the generated context information to the security gateway (S1026).

The traffic forwarding agent may transmit the context information by including it in HTTP extension header field, the SOCKS authentication extension field, or the like. Accordingly, the traffic forwarding agent transmits the context information to the security gateway using HTTP tunneling or SOCKS tunneling.

After operation S1020, the security gateway performs context-based access control of the endpoint to the cloud service using the context information transmitted from the endpoint (operation S1030).

The security gateway blocks or allows a connection of the endpoint to the cloud service by using the context information transmitted by the traffic forwarding agent and access policy information for the cloud service.

When receiving a connection to the cloud service requested by the traffic forwarding agent, the security gateway performs access control to block or allow access to the cloud service by comparing the context information, such as a user, an endpoint, a client, a server, and the like, included in connection request information with the access policy information that indicates whether to block or allow access according to conditions, such as a user, an endpoint, a client, a server, and the like. When the access is allowed, the security gateway forwards the connection to the cloud service, which is a final destination. The context information includes a domain name of a cloud service, as well as an IP address of a cloud service.

According to the present invention, when a client's connection request to a cloud service is forwarded from an endpoint to a security gateway, context information, which is connection information, is transmitted together by including a domain name of the cloud service in the context information, so that access control of the endpoint to the cloud service may be performed based on the domain name of the cloud service.

Accordingly, regardless of the protocol used to connect to a cloud service, the client includes a domain name of the cloud service in the context information and forwards the context information to a security gateway, so that even for application cloud services and database cloud services that do not use HTTP and HTTPS, as well as web cloud services that use HTTP and HTTPS, access to a corresponding cloud service can be controlled and monitored by blocking or allowing access by a security gateway based on the corresponding cloud domain name.

The system and method for access control based on a domain name of a cloud service according to the present disclosure may be implemented in a software program and applied to various reproduction apparatuses by recording the program in a predetermined computer-readable recording medium. The various reproduction apparatuses may be a PC, a notebook, a portable terminal, and the like. For example, the recording medium may be a hard disk, a flash memory, a RAM, a ROM, or the like which is embedded in each reproduction apparatus, or an optical disk such as a CD-R or a CD-RW, a compact flash card, smart media, a memory stick, and a multimedia card which are external devices of each reproduction apparatus.

Although the embodiments of the present disclosure have been described above, the embodiments disclosed in the specification are not intended to limit the present invention. The scope of the present disclosure should be interpreted through the following claims, and all equivalents thereof should be interpreted as being included within the scope of the present disclosure.

1. A system for access control based on a domain name of a cloud service, comprising:
an endpoint configured to look up a domain name for at least one cloud service among a web cloud service, an application cloud service, and a database cloud service and transmit context information including the looked up name; and
a security gateway configured to set up a domain name list of the cloud service and perform context-based access control of the endpoint to the cloud service using the context information transmitted from the endpoint,
wherein the endpoint comprises:
a domain name system (DNS) client configured to store domain cache information including the domain name and an IP address corresponding to the domain name; and
a traffic forwarding agent configured to update domain matching information for each IP address of the domain name list provided from the security gateway by first looking up the domain cache information stored in the DNS client, and when the IP address of the domain name list does not exist in the domain cache information, update the domain matching information by looking up a DNS server, generate the context information for the cloud service through a lookup of the domain cache information or the domain matching information, and transmit the generated context information to the security gateway, and
wherein the traffic forwarding agent is configured to generate the context information by first looking up the domain cache information stored in the DNS client, and when the domain name and the IP address for the cloud service do not exist in the domain cache information, may generate the context information by looking up the domain matching information of the traffic forwarding agent, in order to obtain a domain name and an IP address for the cloud service.

2. The system of claim 1, wherein the context information includes an IP address of the cloud service and a domain name corresponding to the IP address.

3. The system of claim 1, wherein the security gateway is configured to block or allow a connection of the endpoint to the cloud service by using the context information transmitted by the traffic forwarding agent and access policy information for the cloud service.

4-5. (canceled)

6. The system of claim 1, wherein the traffic forwarding agent is configured to transmit the context information to the security gateway using either an HTTP tunneling method or a SOCKS tunneling method.

7. A method for access control based on a domain name of a cloud service, comprising:
setting up, at a security gateway, a domain name list of a cloud service including at least one of a web cloud service, an application cloud service, or a database cloud service;
updating, at a traffic forwarding agent of an endpoint, domain matching information for each IP address of the domain name list provided from the security gateway;
generating, at the traffic forwarding agent, context information for the cloud service through a lookup of domain cache information of a DNS client including a domain name and an IP address corresponding to the domain name or the domain matching information stored in the traffic forwarding agent itself and transmitting the generated context information to the security gateway; and
performing, at the security gateway, context-based access control of the endpoint to the cloud service using the context information transmitted from the traffic forwarding agent,
wherein the updating of the domain matching information comprises updating the domain matching information by first looking up the domain cache information stored in the DNS client, and, when the IP address of the domain name list does not exist in the domain cache information, updating the domain matching information by looking up a DNS server, and
wherein the generating of the context information comprises, in order to obtain a domain name and an IP address for the cloud service, generating the context information by first looking up the domain cache information stored in the DNS client, and when the domain name and the IP address for the cloud service do not exist in the domain cache information, generating the context information by looking up the domain matching information.

8. The method of claim 7, wherein the context information includes an IP address of the cloud service and a domain name corresponding to the IP address.

9-10. (canceled)

11. The method of claim 7, wherein the transmitting of the context information to the security gateway comprises transmitting the context information to the security gateway using either an HTTP tunneling method or a SOCKS tunneling method.

12. The method of claim 7, wherein the performing of the context-based access control comprises blocking or allowing a connection of the endpoint to the cloud service by using the context information transmitted by the traffic forwarding agent and access policy information for the cloud service.
